(19) United States
(12) Patent Application Publication
(10) Pub. No.: US 2024/0083293 A1
(43) Pub. Date: Mar. 14, 2024

(54) ELECTRIC VEHICLE CHARGING SYSTEMS WITH SWAPPABLE ENERGY STORAGE UNITS

(71) Applicant: SparkCharge, Inc., Somerville, MA (US)

(72) Inventors: Rifat Alam SIDDIQUE, Waltham, MA (US); Daniel JANOWIEC, South Boston, MA (US)

(73) Assignee: SparkCharge, Inc., Somerville, MA (US)

(21) Appl. No.: 18/466,288

(22) Filed: Sep. 13, 2023

Related U.S. Application Data
(60) Provisional application No. 63/375,636, filed on Sep. 14, 2022.

(51) Int. Cl. B60L 53/80; B60L 53/18; B60L 53/66; B60S 5/06

(52) U.S. Cl. CPC B60L 53/80; B60L 53/18; B60L 53/66; B60S 5/06

(57) ABSTRACT

Modular electric vehicle charging systems and methods are provided which include a swappable energy storage unit and a charger unit. The swappable energy storage unit and the charger unit are operatively coupled via a detachable cable assembly, and at least one control is provided to control charging of an electric vehicle battery by the modular electric vehicle charging system.

### BACKGROUND

Rechargeable batteries have been used for electrical energy storage in a wide variety of applications, including in electric vehicles. Electric vehicles that use rechargeable batteries can include a variety of types of electric vehicles, hybrid electric vehicles, boats, aircrafts, golf carts, etc. Electric chargers and methods of charging electric vehicles have been developed and used for charging rechargeable batteries of the electric vehicles. The chargers are conventionally stationary chargers that use power from the electric power grid. For instance, electric chargers have been developed often use alternating current, and transform the alternating current from one voltage to another, using one or more wire-wound transformers.

### SUMMARY

Shortcomings of the prior art are overcome, and additional advantages are provided through the provision, in one or more aspects, of a system which includes a modular electric vehicle charging system. The modular electric vehicle charging system includes a swappable energy storage unit and a charger unit. In addition, the modular electric vehicle charging system includes a detachable cable assembly to operatively couple the swappable energy storage unit to the charger unit, and at least one control to control charging of an electric vehicle battery by the modular electric vehicle charging system.

In another aspect, a method of manufacturing a modular electric vehicle charging system is provided. The method includes obtaining a portable energy storage unit and a charger unit, and detachably coupling the portable energy storage unit and the charger unit via a detachable cable assembly, where the portable energy storage unit is a swappable energy storage unit. Further, the method includes providing at least one control to control charging of an electric vehicle battery by the modular electric vehicle charging system.

In a further aspect, a method of charging an electric vehicle battery using a modular electric vehicle charging system is provided. The method includes obtaining a portable energy storage unit and a charger unit, and detachably coupling the portable energy storage unit and the charger unit via a detachable cable assembly, where the portable energy storage unit is a swappable energy storage unit. The method further includes electrically coupling the charger unit to the electric vehicle battery via another cable assembly to facilitate charging of the electric vehicle battery by the modular electric vehicle charging system.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is a block diagram of a modular electric vehicle charging system coupled to charge a load, in accordance with one or more aspects of the present invention;

FIG. 2 is elevational depiction of one example of a modular electric vehicle charging system, in accordance with one or more aspects of the present invention;

FIG. 3 is a detailed schematic of one embodiment of a modular electric vehicle charging system, in accordance with one or more aspects of the present invention;

FIG. 4 depicts one embodiment of use of a modular electric vehicle charging system of FIGS. 1-3 to charge an electric vehicle, in accordance with one or more aspects of the present invention;

FIG. 5 depicts one embodiment for charging an energy storage unit of a modular electric vehicle charging system of FIGS. 1-3, in accordance with one or more aspects of the present invention;

FIG. 6 depicts one embodiment of a workflow, in accordance with one or more aspects of the present invention; and

FIG. 7 depicts an example of a computing environment or control to incorporate and use one or more aspects of the present invention.

### DETAILED DESCRIPTION

The accompanying figures, which are incorporated in and form a part of this specification, further illustrate the present invention and, together with this detailed description of the invention, serve to explain aspects of the present invention. Note in this regard that descriptions of well-known systems, devices, processing techniques, etc., are omitted so as to not unnecessarily obscure the invention in detail. It should be understood, however, that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed herein.

Note also that illustrative embodiments are described below using specific code, designs, architectures, protocols, layouts, schematics, or tools only as examples, and not by way of limitation. Furthermore, the illustrative embodiments are described in certain instances using particular hardware, software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

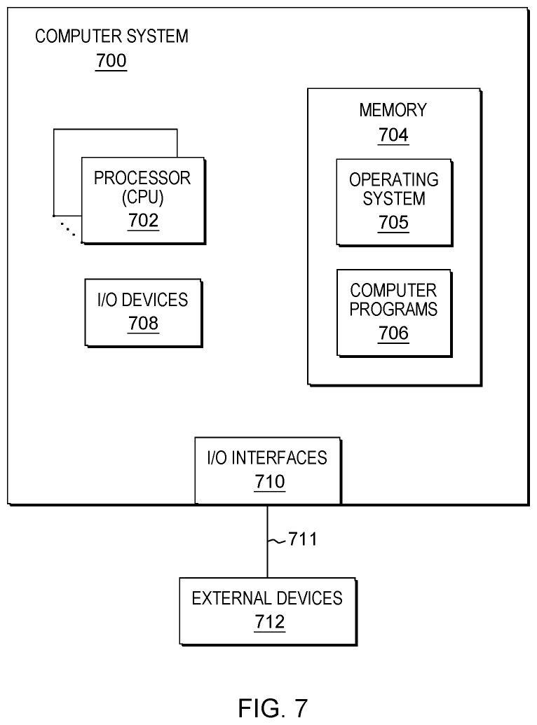

As understood by one skilled in the art, control program code, as referred to in this application, can include both software and hardware. For example, control program code in certain embodiments of the present invention can utilize a software-based implementation of certain functions described, while other embodiments can include (at least in part) fixed function hardware. Certain embodiments can combine both types of program code. Examples of control program code, also referred to as one or more programs, are depicted in FIG. 7 as computer programs 706, which are illustrated by way of example only.

In one or more embodiments, described herein are modular electric vehicle (EV) charging systems for charging an EV battery. In an embodiment, the modular EV charging system(s) provide unidirectional flow of an electric charge using, for instance, direct-current-to-direct-current (DC-DC) conversion, where the electric input is received from a swappable, portable energy storage unit and transmitted, via the modular EV charging system, to the EV battery. According to various embodiments, the EV charging system provides an output of a constant current (CC) or a constant voltage (CV) across a wide DC voltage output range to the EV battery.

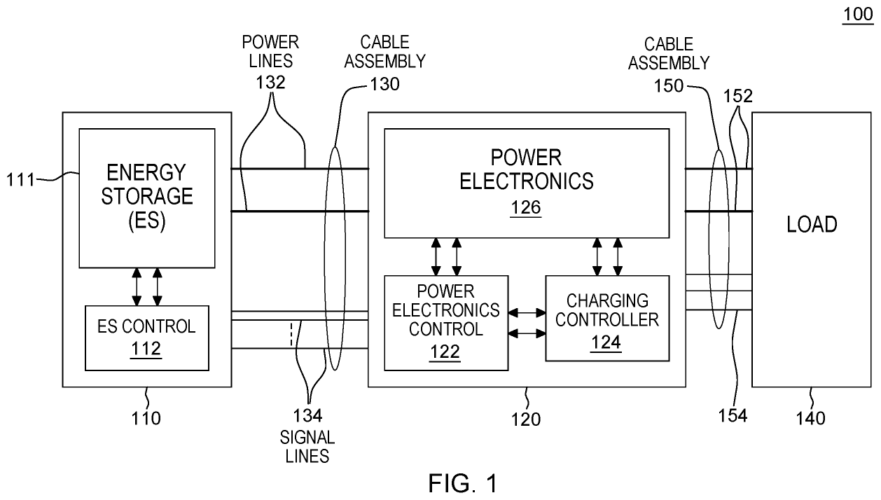

FIG. 1 depicts one embodiment of a modular electric vehicle charging system, generally denoted 100, in accordance with one or more aspects of the present invention. As illustrated, modular electric vehicle charging system 100 includes, in one embodiment, one or more swappable, portable energy storage units 110 with energy storage 111, a charger unit 120, which can also be portable, and a detachable cable assembly 130 operatively coupling portable energy storage unit(s) 110 and charger unit 120. Further, one or more controls are provided to control direct-current charging of a load 140, such as an electric vehicle (EV) battery of an electric vehicle. In one embodiment, the one or more controls include an energy storage control 112 associated with portable energy storage unit(s) 110 to control energy storage 111, as well as a power electronics control 122 and a charging control or controller 124, both of which can be associated with charger unit 120, as shown in FIG. 1. In one or more embodiments, charger unit 120 further includes power electronics 126 controlled by power electronics control 122 and charging controller 124. Power electronics 126 can include, in one or more embodiments, a converter, such as an isolated DC-DC converter, configured to facilitate providing an electric charge to, for instance, an EV battery or other load 140 from a power input, such as from portable energy storage unit(s) 110. The converter of power electronics 126 can be controlled by program code in power electronics control 122 and/or charging controller 124.

As a detailed example, the converter of power electronics 126 can include, for instance, an inrush current-limiting circuit to facilitate the modular electric vehicle charging system charging at a controlled rate when an electric vehicle load is electrically connected to the charging system. Advantageously, an inrush current-limiting circuit can provide longer life expectancy and safer operation for the power components of the modular electric vehicle charging system. After the power passes through the inrush protection circuitry (e.g., inrush current-limiting circuit), the voltage can be bucked or boosted, based on the load (e.g., electric vehicle battery) voltage requirements. Note in this regard that multiple converters can be connected to operate in parallel to maintain the voltage on the output, and supply the current required by the load. In one or more embodiments, each DC-DC converter includes an electromagnetic interference (EMI) filter to inhibit transfer of noise to the load (e.g., electrical vehicle battery). Note that it is also possible that external EMI filtering can be provided as well. In one or more implementations, after filtering the current, the current can also pass through unidirectional circuitry that, for instance, prevents an electric vehicle battery load from providing power-back (i.e., discharging) into the modular electric vehicle charging system. Advantageously, unidirectional current circuitry can ensure that power is only being provided to, for instance, the EV battery, and does not remove power from the EV battery. However, in one or more other embodiments, the unidirectional current circuitry can be omitted from the modular electric vehicle charging system, if desired.

In one or more embodiments, the power electronics control 122 and/or charging controller 124, can include electronic control circuitry, or control code, that controls the DC-DC control system of the converter of the power electronics 126. Additionally, these controllers can include vehicle communication circuitry that is configured to establish charging protocols between, for instance, the DC-DC control system and the EV battery. Note that, in one or more other embodiments, bidirectional current circuitry can be provided within power electronics 126 to allow selective charging of the load by the modular electric vehicle charging system, or charging of the portable energy storage unit from the load, such as an electric vehicle battery, or other power source, if desired.

As illustrated in FIG. 1, cable assembly 130 includes one or more power lines 132 for transferring, in one embodiment, DC power from portable energy storage unit(s) 110 to charger unit 120 for charging load 140. In addition, one or more communication or signal lines 134 are provided for facilitating operative communication between energy storage control 112 and power electronics control 122, such as described herein. In one embodiment, energy storage control 112 and power electronics control 122 automatically communicate charger-related parameters and ensure safety between the energy storage unit and the charger unit. For instance, in one or more embodiments, program code, implemented as hardware, software, or a combination of hardware and software, is provided within one or more of energy storage control 112 and power electronics control 122 to detect (for instance) that portable energy storage unit(s) 110 is coupled to charger unit 120, via detachable cable assembly 130. Note that, in one or more embodiments, power electronics control 122 can also include program code to facilitate communication between charger unit 120, portable energy storage unit(s) 110, and load 140, such as with an electric vehicle control associated with the electric vehicle load. In one embodiment, another detachable cable assembly 150 is provided to operatively couple charger unit 120 to load 140, with the other removable cable assembly 150 including one or more power lines 152 and one or more communication or signal lines 154. Note that in one embodiment, the one or more power lines 132 of detachable cable assembly 130, and the one or more power lines 152 of the other detachable cable assembly 150, can each include a direct-current plus (DC+) line and a direct-current (DC−) line to facilitate optimal charging of the load, such as an electric vehicle battery load.

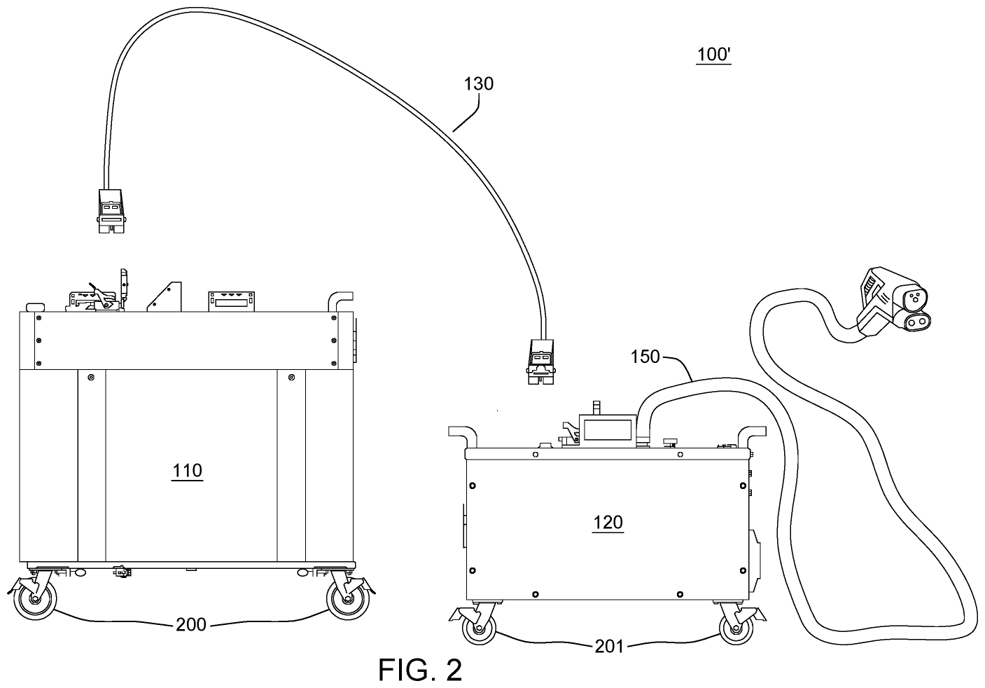

FIG. 2 depicts one example of a modular electric vehicle charging system 100′, such as modular electric vehicle charging system 100 described above in connection with FIG. 1. In this example, modular electric vehicle charging system 100′ includes a swappable, portable energy storage unit 110, such as described above (which can include as DC energy source a battery-based energy storage unit, a fuel cell-based energy storage unit, etc.), and a portable charger unit 120, operatively coupled together via a detachable cable assembly 130. In the example of FIG. 2, portable energy storage unit 110 resides on wheels 200, and portable charger unit 120 resides on wheels 201, which facilitates mobility of the energy storage unit and the charger unit. Note that other modes of mobility or transport can also be used to ensure separate removability and portability of the energy storage unit and charger unit. In one or more configurations, note that the modular electric vehicle charging system is not permanently connected to an AC grid. In the example of FIG. 2, mobile charger unit 120 further includes another cable assembly 150, which in the embodiment illustrated, is permanently affixed to the charger unit at one end, and has an appropriately configured connector at the other end, which can be selectively coupled to an electric vehicle to facilitate charging of the electric vehicle. Note also that, in one or more other embodiments, detachable cable assembly 130 can be permanently affixed to the portable charger unit, as well, if desired.

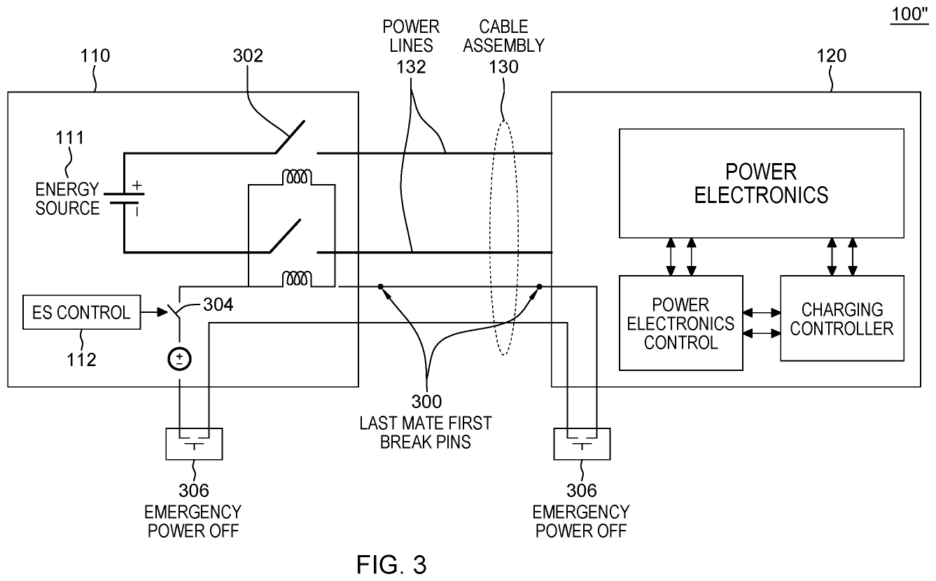

FIG. 3 depicts a further embodiment of a modular electric vehicle charging system 100″, such as modular electric vehicle charging system 100 of FIG. 1 and/or modular electric vehicle charging system 100″ of FIG. 2. By way of example, modular electric vehicle charging system 100″ of FIG. 3 illustrates further details of one embodiment of a safety implementation, where the contactors of the energy source run through, for instance, a custom cable using last-mate, first-break pins (or connectors) 300 at each end in a safety control loop implemented between energy storage unit(s) 110 and charger unit 120. As illustrated, the safety loop is coupled to control switches, such as solenoid-controlled switches 302 in energy storage unit 110 in-line with, or coupled to power lines 132. In this manner, detachable cable assembly 130 is part of the safety mechanism. If one end of the cable is removed, for instance, accidently removed, then the relays will turn OFF automatically, without the need for any outside intervention. Additional safety is ensured by last-mate, first-break pins (or connectors) 300 being coupled to control power relays 302. In addition, in one embodiment, energy storage control 112 can be configured to control a switch 304 in the safety loop which allows the control to automatically turn ON or OFF the supply of energy from the energy storage unit. Further, power-off switches 306 can be provided on both the energy storage unit(s) 110 and charger unit 120 to allow, for instance, an operator to manually switch OFF and safely shut down supply of power from the energy storage. In one embodiment, switches 306 can be emergency power-off (EPO) switches.

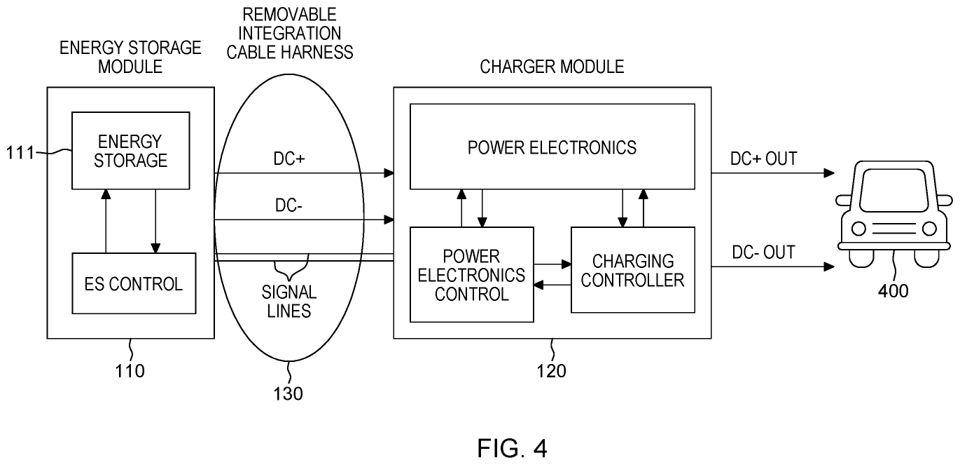

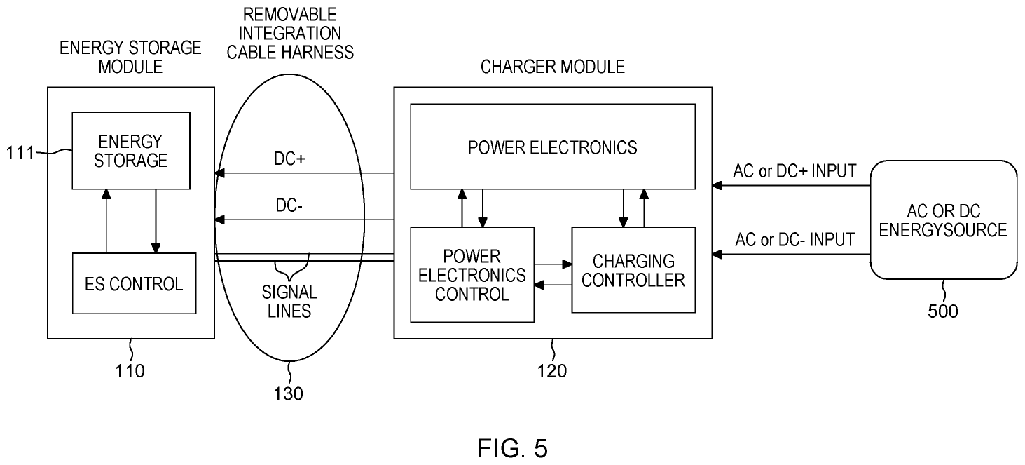

FIG. 4 depicts one embodiment of modular electric vehicle charging system 100 (in accordance with one or more aspects of the present invention) shown charging an electric vehicle via power output signals including a DC+ output and a DC− output. In this embodiment, charger unit 120 can be a unidirectional charger, or a bidirectional charger, and can either be isolated or non-isolated for the charging of the electric vehicle 400. In one or more other embodiments, the charger unit can be a bidirectional charger, as illustrated in FIG. 5, to facilitate charging one or more energy storage units 110 via a different DC energy source 500, and/or via an AC connection, such as an AC connection to a power grid. In this manner, a unidirectional or bidirectional charger can be provided capable of charging one or more energy storage units from outside power sources (e.g., via an AC main grid source, a Level 1, 2, or 3 EV charger source, etc.).

Note that, in one or more embodiments, disclosed herein is a portable electric vehicle (EV) charger system that is able to charge electric vehicles inside or outside, for instance a commercialized cargo vehicle or container. The system connects to removeable and swappable battery units or modules, that can also be located within the cargo vehicle or container, via a removable or detachable cable assembly or harness. The energy storage units, or battery modules, are the input energy source to the system. The modular electric vehicle charging system, in one embodiment, is a portable EV charging system that accommodates swapping input energy source units (e.g., batteries) using the removable cable assembly. In one embodiment, the modular electric vehicle charging system has a unidirectional or bidirectional DC/DC converter to take power in from one end of the device, and to deliver boosted (or bucked) power to the other end of the device. The modular electric vehicle charging system is, in one embodiment, able to vary and deliver, for instance, up to 90 kW of power to a vehicle using a standard connector/cable end that a device user can plug into an electric vehicle (using, for instance, Combined Charging System (CCS), CHAdeMO, North American Charging Standard (NACS)). The modular electric vehicle charging system is also configured, in one embodiment, to update power availability and delivery instantaneously, based on conditions of the vehicle being charged and conditions of the portable energy storage unit(s). In one embodiment, the modular electric vehicle charging system can output electric energy in one of multiple modes, including: constant power, constant voltage, or constant current.

In one or more embodiments, the modular electric vehicle charging system can contain one or more integrated cooling systems that are able to cool the system for maintaining high-power deliver for an extended period of time, without efficiency loss. For instance, in one or more embodiments, one or both of the energy storage unit and charger unit can include an integrated cooling system, such as a closed loop, coolant-based cooling system controlled by one or more control modules of the system. In one or more other embodiments, one or both of the energy storage unit and charger unit can include forced air-cooling that is controlled, for instance, by one or more control modules of the system.

In one or more embodiments, the modular electric vehicle charging system can power auxiliary line components by using power delivered from the swappable, portable energy storage unit(s), and converting it to lower voltage using one or more separate, smaller converter boards.

In one or more embodiments, the modular electric vehicle charging system is configured to be capable of recharging the portable energy storage unit(s) from, for instance, a stationary charging station, such as a Level 1, Level 2, or Level 3, charging station (including DC fast-charging). In one embodiment, the portable energy storage unit is able to be recharged individually using, for instance, power supplies tied to a grid service, or the energy storage unit can be recharged using electric vehicle on-board chargers, that is, by removing energy from an electric vehicle battery back to the mobile energy storage unit, if desired in one embodiment.

In one embodiment, the charger unit is also a mobile or portable charger unit that is able, for instance, to be secured in a vehicle or container, such as a cargo vehicle or container, using standard cargo restraints. Similarly, the portable energy storage unit(s) can be configured, in one embodiment, to be secured within a vehicle or container, such as a cargo vehicle or container, using standard cargo restraints.

In one or more embodiments, the charger unit is a mobile charger unit that is capable of being positioned where needed, and locked in place to remain stationary for use by an operator. In one embodiment, the mobile charger unit is on lockable wheels, or lockable caster wheels. Similarly, the portable energy storage unit can be configured for movement to where needed, and be locked in place into a stationary position for use by an operator.

In one or more embodiments, the charger unit is a portable charger unit capable of being lifted by, for instance, one or two operators, and can be provided with handles, if desired. Alternatively, the charger unit can be configured for lifting using a standard lift tool device. In one embodiment, the charger unit weighs, for instance, less than 250 lbs. In one or more implementations, the charger unit contains a port-side connector to manually gather internal data and status from the electric vehicle or other electric device being charged, as well as from the energy storage unit(s) when operatively coupled to the energy storage unit via a detachable cable assembly, such as described herein.

In one or more implementations, the charger unit is configured to internally measure input and output power through the charger unit. Similarly, the portable energy storage unit is configured, in one or more embodiments, to monitor power levels as well.

In one or more embodiments, the charger unit is configured to visually display power and/or energy delivery rates, system status, any error conditions, etc. Similarly, the portable energy storage unit can be configured with a visual display to similarly display power and/or energy delivery rates, system status, any error conditions, etc.

In one or more embodiments, the charger system can be configured to suppress or prevent critical faults, such as over-voltage, over-current, short circuits, and over-temperature, from occurring. In one or more implementations, the portable energy storage unit(s) can be similarly configured.

In one or more embodiments, the charger unit can be configured to connect to a secure network (such as via the Internet) for, for instance, remote control, remote firmware updates, offloading of any data logged from the modular electric vehicle charging system to a secured remote application server, etc. This can involve transfer of data and communications across one or more networks, such as one or more cellular networks, local-area networks (LANs), wide-area networks (WANs), etc. Further, in one or more embodiments, the charger unit, and in particular, the power electronics control or charging controller of the charger unit, can be configured to bidirectionally communicate with a control of the electric vehicle or other electric load being charged, to facilitate the charging process.

In one specific embodiment, the swappable, portable energy storage unit can include two 35 kW/h battery packs (by way of example only), integrated together through an interface box, for instance, via cable harnesses and a computer control board. In one example embodiment, the portable energy storage unit is configured to output up to 795 volts. In another example embodiment, the portable energy storage unit is configured to output up to 250 amps.

In one or more particular embodiments, the portable energy storage unit(s) can be configured to discharge up to 112 kW of power continuously, or to discharge up to 224 kW of power for 30 seconds. In one or more embodiments, the portable energy storage unit(s) can be configured to provide auxiliary power. Further, in one or more embodiments, the portable energy storage unit(s) can be configured to connect to more than a single charger unit, or to more than a single charger unit design or type.

Further, in one or more embodiments, the energy storage unit can be configured to be connected in parallel or in-series with one or more other energy storage units within the modular electric vehicle charging system to, for instance, increase continuous power output from the modular electric vehicle charging system.

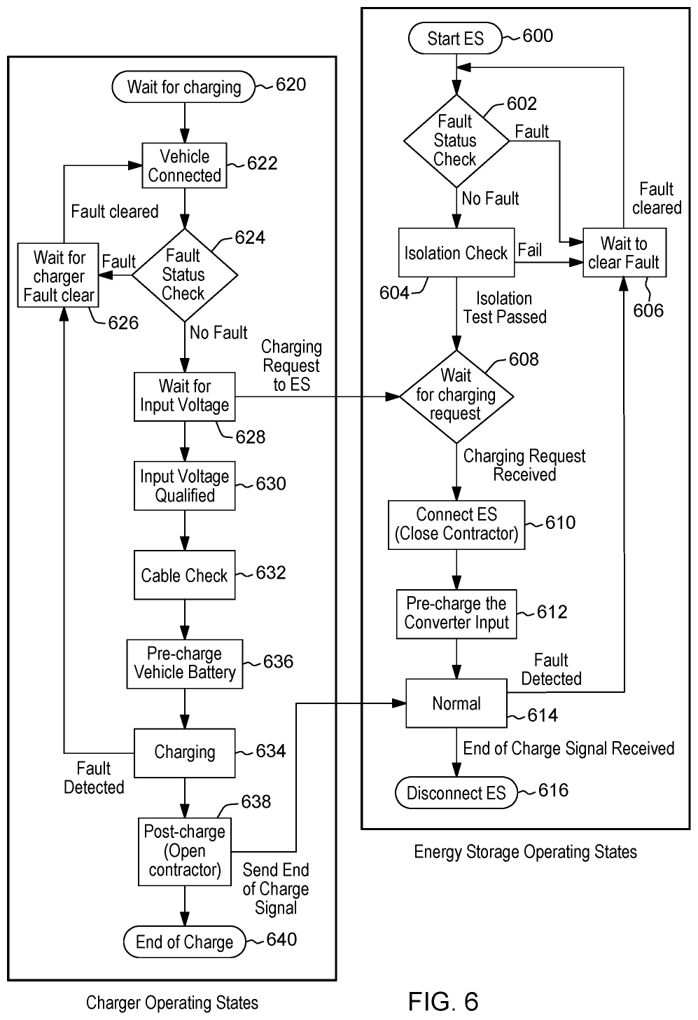

FIG. 6 depicts one embodiment of a workflow, in accordance with one or more aspects of the present invention. The workflow, or state diagram, includes one embodiment of energy storage operating states, and charger operating states.

As illustrated, an energy storage unit is started 600, and control checks fault status 602. If there is a fault, processing waits to clear the fault 606, before proceeding to perform an isolation check 604. Assuming that the isolation check passes, control then waits for a charge request 608. Based on receipt of a charging request, the control closes the contactor bus to connect the energy storage unit to the charge unit 610, and pre-charges the converter input 612. Normal charging 614 then proceeds until an end of charge signal is received, based on which the control disconnects the energy storage unit 616 from the charger unit (i.e., opens the contactor bus). If, during normal charging, a fault is detected, then the control pauses charging until the fault is cleared.

Referring to the charger unit operating states, the charger unit waits for a charging request 620, and determines that a vehicle is connected 622 to the electric vehicle charging system. Control performs a fault status check 624, and if there is a fault, waits for the charger fault to clear 626. Otherwise, control waits for input voltage to be received 628 pursuant to a charging request to the energy storage unit. Charger control qualifies the input voltage 630, checks the charge cable 632, and pre-charges the vehicle battery 634, at which point, full charging of the electric vehicle battery begins 636. If a fault is detected, the control waits for the charger fault to clear before proceeding with charging. Once charging is complete, the power connector bus is opened 638, and an end of charge signal is sent to the energy storage unit control, which ends charge control processing 640 pursuant to the charge request.

Those skilled in the art will note from the description provided, that disclosed herein are modular electric vehicle charging systems, methods of manufacturing modular electric vehicle charging systems, and methods of charging electric vehicle batteries using modular electric vehicle charging systems. In one embodiment, the modular electric vehicle charging system includes a swappable energy storage unit, a charger unit, and a detachable cable assembly to operatively couple the swappable energy storage unit to the charger unit. Further, the modular electric vehicle charging system includes at least one control to control charging of an electric vehicle battery by the modular electric vehicle charging system. Advantageously, the modular electric vehicle charging system including the swappable energy storage unit and the detachable cable assembly allows the energy storage unit to be readily replaced or swapped out when energy stored within the energy storage unit is depleted.

In the foregoing, and/or alternative, system embodiments, the swappable energy storage unit includes a portable energy storage unit, and the charger unit includes a portable charger unit. The swappable energy storage unit being a portable energy unit, and the charger unit being a portable charger unit advantageously allows for ready replacement of the energy storage unit and/or charger unit within the modular electric vehicle charging system, for instance, by detaching and reattaching the detachable cable assembly operatively coupling the energy storage and charger units.

In any of the foregoing, and/or alternative, system embodiments, the portable energy storage unit and the portable energy charger unit are in separate portable enclosures, and are integrated into the modular electric vehicle charging system by the detachable cable assembly operatively coupling the portable energy storage unit and the portable charger unit. With the portable energy storage unit and portable charger unit being in separate portable enclosures, and being integrated into the modular electric vehicle charging system by the detachable cable assembly operatively coupling the portable energy storage unit and the portable charging unit, the portable energy storage unit and the portable charger unit in the separate portable enclosures can be readily replaced, for instance, with depletion of energy stored in the portable energy storage unit, or detecting a defect or other issue with either the portable energy storage unit or the portable charger unit.

In any of the foregoing, and/or alternative, system embodiments, the detachable cable assembly includes a first last-mate, first-break connector at one end, and a second last-mate, first-break connector at another end, where the first last-mate, first-break connector at the one end of the detachable cable assembly operatively couples to the swappable energy storage unit, and the second last-mate, first-break connector at the other end of the detachable cable assembly operatively couples to the charger unit. Advantageously, the detachable cable assembly being configured with the first last-mate, first-break connector at one end, and the second last-mate, first-break connector at the other end, enhances safety of the modular electric vehicle charging system by, for instance, automatically turning OFF the detachable cable assembly should, for instance, one end of the cable be removed. With the last-mate, first-break connectors at the different ends of the detachable cable assembly, the connectors turn OFF automatically, without the need for outside intervention.

In any of the foregoing, and/or alternative, system embodiments, the swappable energy storage unit and the charger unit each have a respective emergency power OFF switch to shut OFF supply of power from the swappable energy storage unit. In this manner, the safety loop is further enhanced by allowing, for instance, a control of the energy storage unit, or a control of the charger unit, to automatically turn ON or OFF the supply of energy from the energy storage unit or energy charger unit, respectively.

In any of the foregoing, and/or alternative, system embodiments, the detachable cable assembly includes one or more power lines to supply direct-current power from the swappable energy storage unit to the charger unit for charging the electric vehicle battery, and one or more signal lines, where the one or more signal lines facilitate communication between an energy storage control of the swappable energy storage unit, and a power electronics control of the charger unit, to facilitate, at least in part, control of supply of power from the swappable energy storage unit to the charger unit. Advantageously, the single detachable cable assembly operatively couples the swappable energy storage unit and the charger unit, and includes power lines to supply direct-current power from the swappable energy storage unit to the charger unit for charging the electric vehicle battery, as well as signal lines for facilitating communication between the energy storage control of the swappable energy storage unit and the power electronics control of the charger unit.

In any of the foregoing, and/or alternative, system embodiments, the charger unit includes one of a unidirectional charger unit or a bidirectional charger unit, and is isolated or non-isolated for charging the electric vehicle battery. Advantageously, unidirectional current circuitry can ensure that power is only being provided to, for instance, the electric vehicle battery, and the system does not remove power from the electric vehicle battery. Where the charger unit is a bidirectional charger, charging of one or more energy storage units is facilitated, for instance, from a different DC energy source, and/or via an AC connection, such as an AC connection to a power grid, if desired. In this manner, the charger can be capable of charging one or more energy storage units from outside power sources.

In any of the foregoing, and/or alternative, system embodiments, the swappable energy storage unit is one swappable energy storage unit of multiple swappable energy storage units operatively connected to the charger unit. The modular electric vehicle charging system including multiple swappable energy storage units extends the capacity of the modular electric vehicle charging system to charge one or more electric vehicle batteries. In any of the foregoing, and/or alternative, system embodiments, each swappable energy storage unit of the multiple swappable energy storage units is operatively coupled to the charger unit through a respective detachable cable assembly. By separately coupling each swappable energy storage unit to the charger unit through a respective detachable cable assembly, each depleted swappable energy storage unit can be readily detached from the electric vehicle charging system and replaced with, for instance, another swappable energy storage unit that is fully charged.

In any of the foregoing, and/or alternative, system embodiments, the swappable energy storage unit is detachable from the charger unit by the detachable cable assembly to be replaced by another swappable energy storage unit when stored energy of the swappable energy storage unit drops below a specified threshold. In this manner, stored energy within the modular electric vehicle charging system can be maintained at or above the specified threshold to facilitate, for instance, charging of the electric vehicle battery.

In another embodiment, a method of manufacturing the modular electric vehicle charging system is provided, which includes obtaining a portable energy storage unit and a charger unit, and detachably coupling the portable energy storage unit and the charger unit via a detachable cable assembly, where the portable energy storage unit is a swappable energy storage unit. Further, the method of manufacturing the modular electric vehicle charging system includes providing at least one control to control charging of an electric vehicle battery by the modular electric vehicle charging system. Advantageously, the modular electric vehicle charging system manufactured includes the swappable energy storage unit and the detachable cable assembly, and allows the energy storage unit to be readily replaced or swapped out when energy stored within the energy storage unit is depleted.

In the foregoing, and/or alternative, method embodiments, the charger unit includes a portable charger unit, and the portable energy storage unit and the portable charger unit are in separate portable enclosures, and are integrated into the modular electric vehicle charging system by the detachable cable assembly operatively coupling the portable energy storage unit and the portable charger unit. With the portable energy storage unit and portable charger unit being in separate portable enclosures, and being integrated into the modular electric vehicle charging system by the detachable cable assembly operatively coupling the portable energy storage unit and the portable charging unit, the portable energy storage unit and the portable charger unit in the separate portable enclosures can be readily replaced, for instance, upon depletion of energy stored in the portable energy storage unit, or upon detecting a defect or other issue with either the portable energy storage unit or the portable charger unit.

In any of the foregoing, and/or alternative, method embodiments, the detachable cable assembly includes a first last-mate, first-break connector at one end, and a second last-mate, first-break connector at another end, where the detachably coupling includes detachably coupling the first last-mate, first-break connector at the one end of the detachable cable assembly to the portable energy storage unit, and the second last-mate, first-break connector at the other end of the detachable cable assembly to the charger unit to operatively couple the portable energy storage unit and the charger unit. Advantageously, the detachable cable assembly being configured with the first last-mate, first-break connector at the one end, and the second last-mate, first-break connector at the other end, enhances safety of the modular electric vehicle charging system by, for instance, automatically turning OFF the detachable cable assembly should, for instance, one end of the cable be removed. With the last-mate, first-break connectors at the different ends of the detachable cable assembly, the connector is turned OFF automatically, without the need for outside intervention.

In any of the foregoing, and/or alternative, method embodiments, the swappable energy storage unit and the charger unit each have a respective emergency power OFF switch to shut OFF supply of power from the portable energy storage unit. In this manner, the safety loop is further enhanced by allowing, for instance, a control of the energy storage unit, or a control of the charger unit, to automatically turn ON or OFF the supply of energy from the energy storage unit or the energy charger unit, respectively.

In any of the foregoing, and/or alternative, method embodiments, the detachable cable assembly includes one or more power lines to supply direct-current power for the portable energy storage unit to the charger unit for charging the electric vehicle battery, and one or more signal lines, where the one or more signal lines facilitate communication between an energy storage control of the portable energy storage unit, and a power electronics control of the charger unit, to facilitate, at least in part, control of supply of power from the portable energy storage unit to the charger unit. Advantageously, the single detachable cable assembly operatively couples the swappable energy storage unit and the charger unit, and includes power lines to supply direct-current power from the swappable energy storage unit to the charger unit for charging the electric vehicle battery, as well as signal lines for facilitating communication between the energy storage control of the portable energy storage unit and the power electronics control of the charger unit.

In any of the foregoing, and/or alternative, method embodiments, the charger unit includes one of a unidirectional charger unit or a bidirectional charger unit, and is isolated or non-isolated for charging the electric vehicle battery. Advantageously, unidirectional current circuitry can ensure that power is only being provided to, for instance, the electric vehicle battery, and the system does not remove power from the electric vehicle battery. Where the charger unit is a bidirectional charger, charging of one or more energy storage units is facilitated, for instance, from a different DC energy source, and/or via an AC connection, such as an AC connection to a power grid, if desired. In this manner, the charger can be capable of charging the portable energy storage unit from one or more outside power sources.

In any of the foregoing, and/or alternative, method embodiments, the portable energy storage unit is one portable energy storage unit of multiple portable energy storage units operatively coupled to the charger unit, where each portable energy storage unit of the multiple portable energy storage units is operatively coupled to the charger unit through a respective detachable cable assembly. With the modular electric vehicle charging system including multiple portable energy storage units, capacity of the modular electric vehicle charging system can be extended to charge, for instance, one or more electric vehicle batteries. Also, by separately coupling each portable energy storage unit to the charger unit through a respective detachable cable assembly, each depleted portable energy storage unit can be readily detached from the electric vehicle charging system and replaced with, for instance, another portable energy storage unit that is fully charged.

In any of the foregoing, and/or alternative, method embodiments, the portable energy storage unit is configured to be replaced by another portable energy storage unit when stored energy of the portable energy storage unit drops below a specified threshold. In this manner, stored energy within the modular electric vehicle charging system can be maintained at or above the specified threshold to facilitate, for instance, charging of the electric vehicle battery.

In a further embodiment, a method of charging an electric vehicle battery using the modular electric vehicle charging system is provided. The method includes obtaining a portable energy storage unit and a charger unit, and detachably coupling the portable energy storage unit and the charger unit using a detachable cable assembly, where the portable energy storage unit is a swappable energy storage unit. Further, the method of charging includes electrically coupling the charger unit to the electric vehicle battery via another cable assembly to facilitate charging the electric vehicle battery by the modular electric vehicle charging system. Advantageously, the modular electric vehicle charging system including the swappable energy storage unit and detachable cable assembly allows the energy storage unit to be readily replaced or swapped out once energy stored within the energy storage unit has been depleted.

In the foregoing, and/or alternative, method embodiments, the method further includes monitoring stored energy of the portable energy storage unit, and swapping out the portable energy storage unit from the modular electric vehicle charging system with another portable energy storage unit when stored energy of portable energy storage unit drops below a specified threshold. In this manner, stored energy within the modular electric vehicle charging system can be maintained at or above the specified threshold to facilitate, for instance, charging of the electric vehicle battery.

By way of further example, FIG. 7 depicts a computer system 700, or control or controller, in communication with external device(s) 712, which can be used to implement one or more aspects disclosed herein. Computer system 700 includes one or more processor(s) 702, for instance central processing unit(s) (CPUs). A processor can include functional components used in the execution of instructions, such as functional components to fetch program instructions from locations such as cache or main memory, decode program instructions, and execute program instructions, access memory for instruction execution, and write results of the executed instructions. A processor 702 can also include one or more registers to be used by one or more of the functional components. Computer system 700 also includes a memory 704, input/output (I/O) devices 708, and I/O interfaces 710, which may be coupled to processor(s) 702 and each other via one or more buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and Peripheral Component Interconnect (PCI).

Memory 704 can be, or include, main or system memory (e.g. Random Access Memory) used in the execution of program instructions, a storage device(s) such as hard drive(s), flash media, or optical media as examples, and/or cache memory, as examples. Memory 704 can include, for instance, a cache, such as a shared cache, which may be coupled to local caches (examples include L1 cache, L2 cache, etc.) of processor(s) 702. Additionally, memory 704 can be, or include, at least one computer program product having a set (e.g., at least one) of program modules, instructions, code or the like that is/are configured to carry out functions of embodiments described herein when executed by one or more processors.

Memory 704 can store an operating system 705 and other computer programs 706, such as one or more computer programs/applications that execute to perform aspects described herein. Specifically, programs/applications can include computer readable program instructions that can be configured to carry out functions of embodiments of aspects described herein.

Examples of I/O devices 708 include but are not limited to microphones, speakers, Global Positioning System (GPS) devices, cameras, lights, accelerometers, gyroscopes, magnetometers, sensor devices configured to sense proximity, temperature, etc. An I/O device can be incorporated into the computer system as shown, though in some embodiments an I/O device can be regarded as an external device (712) coupled to the computer system through one or more I/O interfaces 710.

Computer system 700 can communicate with one or more external devices 712 via one or more I/O interfaces 710. Example external devices include a keyboard, a display, one or more data sensors, and/or any other devices or control systems that (for instance) enable a user or other system to interact with computer system 700. Other example external devices include any device that enables computer system 700 to communicate with one or more other computing systems or peripheral devices. A network interface/adapter is an example I/O interface that enables computer system 700 to communicate with one or more networks, such as a local area network (LAN), a general wide area network (WAN), and/or a public network (e.g., the Internet), providing communication with other computing devices or systems, storage devices, or the like. Ethernet-based (such as Wi-Fi) interfaces and Bluetooth® adapters are just examples of the currently available types of network adapters used in computer systems. (BLUETOOTH® is a registered trademark of Bluetooth SIG, Inc., Kirkland, Washington, U.S.A.)

Communication between I/O interfaces 710 and external devices 712 can occur across wired and/or wireless communications link(s) 711, such as Ethernet-based wired or wireless connections. Example wireless connections include cellular, Wi-Fi, Bluetooth®, proximity-based, near-field, or other types of wireless connections. More generally, communications link(s) 711 can be any appropriate wireless and/or wired communication link(s) for communicating data between systems and/or devices to facilitate one or more aspects disclosed herein.

A particular external device(s) 712 can include one or more data storage devices, which can store one or more programs, one or more computer readable program instructions, and/or data, etc. Computer system 700 can include and/or be coupled to and in communication with (e.g., as an external device of the computer system) removable/non-removable, volatile/non-volatile computer system storage media. For example, it can include and/or be coupled to a solid-state device (SSD), or other non-volatile media, to store data persistently.

Computer system 700 can be operational with numerous other general purpose or special purpose computing system environments or configurations. Computer system 700 can take any of various forms, well-known examples of which include, but are not limited to, personal computer (PC) system(s), server computer system(s), thin client(s), thick client(s), workstation(s), laptop(s), handheld device(s), mobile device(s)/computer(s), such as smartphone(s), tablet(s), multiprocessor system(s), microprocessor-based system(s), network appliance(s) (such as edge appliance(s)), virtualization device(s), storage controller(s), programmable electronic(s), network PC(s), minicomputer system(s), mainframe computer system(s), and distributed cloud computing environment(s) that include any of the above systems or devices, and the like.

As will be appreciated by one skilled in the art, control aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, control aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may be any non-transitory computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a solid-state device (SSD), a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

In one example, a computer program product includes, for instance, one or more computer readable storage media to store computer readable program code means or logic thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out control and/or calibration operations for aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on the user's computer, partly on the user's computer, on the user's personal device (e.g., phone, tablet, wearable), as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to block diagrams of methods, apparatus (systems) and computer program products according to embodiments of the invention. It will be understood that the control block of the diagram can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus (e.g., mobile device/phone), or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The block diagram in the figure illustrates the architecture, functionality, and operation of possible implementations of systems, methods and computer program products according to various embodiments of the present invention. In this regard, one or more blocks in the diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that one or more blocks of the diagram can be implemented by special purpose hardware-based systems that perform the specified functions or acts, or combinations of special purpose hardware and computer instructions.

In addition to the above, one or more aspects of the present invention may be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider may receive payment from the customer under a subscription and/or fee agreement, as examples. Additionally or alternatively, the service provider may receive payment from the sale of advertising content to one or more third parties.

In one aspect of the present invention, an application may be deployed for performing one or more aspects of the present invention. As one example, the deploying of an application comprises providing computer infrastructure (including, e.g., internet/cloud/IOT resources and/or a mobile device) operable to perform one or more aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of the present invention. The code in combination with the computer system is capable of performing one or more aspects of the present invention.

A popular type of computing is cloud computing, in which resources can interact and/or be accessed via a communications system, such as a computer network. Resources can be software-rendered simulations and/or emulations of computing devices, storage devices, applications, and/or other computer-related devices and/or services run on one or more computing devices, such as a server. For example, a plurality of servers can communicate and/or share information that can expand and/or contract across servers depending on an amount of processing power, storage space, and/or other computing resources needed to accomplish the requested task.

Cloud computing can be provided as a service over the Internet, such as in the form of “Infrastructure as a Service” (IaaS), “Platform as a Service” (PaaS), and/or “Software as a Service” (SaaS). IaaS can typically provide physical or virtual computing devices and/or accessories on a fee-for-service basis, and onto which clients/users can load and/or install, and management, platforms, applications, and/or data. PaaS can deliver a computing platform and solution stack as a service, such as, for example, a software development platform, application services, such as team collaboration, web service integration, database integration, and/or developer community facilitation. SaaS can deploy software licensing as an application to customers for use as a service on-demand. SaaS software vendors can host the application on their own clouds, or download such applications from clouds to cloud clients, disabling the applications after use, or after an on-demand contract expires.

The provision of such services allows a user access to as much in the way of computing resources as a user needs without purchasing and/or maintaining the infrastructure, such as hardware and/or software, that would be required to provide the services. For example, a user can instead obtain access via subscription, purchase, and/or otherwise securing access. Thus, cloud computing can be a cost-effective way to delivery information technology services.

Although various embodiments are described above, these are only examples. For example, computing environments of other architectures can incorporate and use one or more aspects of the present invention. Additionally, the network of nodes can include additional nodes, and the nodes can be the same or different from those described herein. Also, many types of communications interfaces may be used.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, mobile device/phone, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of the invention and the practical application, and to enable others of ordinary skill in the art to understand the invention through various embodiments and the various modifications thereto which are dependent on the particular use contemplated.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A system comprising:
a modular electric vehicle charging system, the modular electric vehicle charging system comprising:
a swappable energy storage unit;
a charger unit;
a detachable cable assembly to operatively couple the swappable energy storage unit to the charger unit; and
at least one control to control charging of an electric vehicle battery by the modular electric vehicle charging system.

2. The system of claim 1, wherein the swappable energy storage unit comprises a portable energy storage unit, and the charger unit comprises a portable charger unit.

3. The system of claim 2, wherein the portable energy storage unit and the portable charger unit are in separate portable enclosures, and are integrated into the modular electric vehicle charging system by the detachable cable assembly operatively coupling the portable energy storage unit and the portable charger unit.

4. The system of claim 1, wherein the detachable cable assembly comprises a first last-mate, first-break connector at one end, and a second last-mate, first-break connector at another end, the first last-mate, first-break connector at the one end of the detachable cable assembly operatively coupling to the swappable energy storage unit, and the second last-mate, first-break connector at the other end of the detachable cable assembly operatively coupling to the charger unit.

5. The system of claim 1, wherein the swappable energy storage unit and the charger unit each have a respective emergency power-off switch to shut OFF supply of power from the swappable energy storage unit.

6. The system of claim 1, wherein the detachable cable assembly comprises one or more power lines to supply direct-current power from the swappable energy storage unit to the charger unit for charging of the electric vehicle battery, and one or more signal lines, the one or more signal lines facilitating communication between an energy storage control of the swappable energy storage unit and a power electronics control of the charger unit to facilitate, at least in part, control of supply of power from the swappable energy storage unit to the charger unit.

7. The system of claim 1, wherein the charger unit comprises one of a unidirectional charger unit or a bidirectional charger unit, and is isolated or non-isolated for charging the electric vehicle.

8. The system of claim 1, wherein the swappable energy storage unit is one swappable energy storage unit of multiple swappable energy storage units operatively connected to the charger unit.

9. The system of claim 8, wherein each swappable energy storage unit of the multiple swappable energy storage units is operatively coupled to the charger unit through a respective detachable cable assembly.

10. The system of claim 1, wherein the swappable energy storage unit is detachable from the charger unit via the detachable cable assembly to be replaced by another swappable energy storage unit when stored energy of the swappable energy storage unit drops below a specified threshold.

11. A method of manufacturing a modular electric vehicle charging system, the method comprising:
obtaining a portable energy storage unit and a charger unit;
detachably coupling the portable energy storage unit and the charger unit via a detachable cable assembly, wherein the portable energy storage unit is a swappable energy storage unit; and
providing at least one control to control charging of an electric vehicle battery by the modular electric vehicle charging system.

12. The method of claim 11, wherein the charger unit comprises a portable charger unit, and wherein the portable energy storage unit and the portable charger unit are in separate portable enclosures, and are integrated into the modular electric vehicle charging system by the detachable cable assembly operatively coupling the portable energy storage unit and the portable charger unit.

13. The method of claim 11, wherein the detachable cable assembly comprises a first last-mate, first-break connector at one end, and a second last-mate, first-break connector at another end, wherein the detachably coupling comprises detachably coupling the first last-mate, first-break connector at the one end of the detachable cable assembly to the portable energy storage unit, and the second last-mate, first-break connector at the other end of the detachable cable assembly to the charger unit to operatively couple the portable energy storage unit and the charger unit.

14. The method of claim 11, further comprising providing an emergency shut-off switch on the portable energy storage unit to shut OFF supply of power from the portable energy storage unit, and providing another emergency power-off switch at the charger unit to shut OFF supply at the charger unit to shut OFF supply of power from the portable energy storage unit.

15. The method of claim 11, wherein the detachable cable assembly comprises one or more power lines to supply direct-current power from the portable energy storage unit to the charger unit for charging of the electric vehicle battery, and one or more signal lines, the one or more signal lines facilitating communication between an energy storage control of the portable energy storage unit and a power electronics control of the charger unit to facilitate, at least in part, control of supply of power from the portable energy storage unit to the charger unit.

16. The method of claim 11, wherein the charger unit comprises one of a unidirectional charger unit or a bidirectional charger unit, and is isolated or non-isolated for charging the electric vehicle.

17. The method of claim 11, wherein the portable energy storage unit is one portable energy storage unit of multiple portable energy storage units operatively coupled to the charger unit, and wherein each portable energy storage unit of the multiple portable energy storage units is operatively coupled to the charger unit through a respective detachable cable assembly.

18. The method of claim 11, wherein the portable energy storage unit is configured to be replaced by another portable energy storage unit when stored energy of the portable energy storage unit drops below a specified threshold.

19. A method of charging an electric vehicle battery using a modular electric vehicle charging system, the method comprising:
obtaining a portable energy storage unit and a charger unit;
detachably coupling the portable energy storage unit and the charger unit via a detachable cable assembly, wherein the portable energy storage unit is a swappable energy storage unit; and
electrically coupling the charger unit to the electric vehicle battery via another cable assembly to facilitate charging of the electric vehicle battery by the modular electric vehicle charging system.

20. The method of claim 19, further comprising monitoring stored energy of the portable energy storage unit, and swapping out the portable energy storage unit from the modular electric vehicle charging system with another portable energy storage unit when stored energy of the portable energy storage unit drops below a specified threshold.
